(19) United States
(12) Patent Application Publication
(10) Pub. No.: US 2024/0399899 A1
(43) Pub. Date: Dec. 5, 2024

(54) In-Wheel Motor with Integrated Wireless Charging

(71) Applicants: Bayerische Motoren Werke Aktiengesellschaft, Muenchen (DE); UT-Battelle, LLC, Oak Ridge, TN (US)

(72) Inventors: Vincent MOLINA, Menlo Park, CA (US); Bernhard HOESS, Muenchen (DE); Mostak MOHAMMAD, Knoxville, TN (US); Veda Prakash GALIGEKERE, Knoxville, TN (US); Vandana RALLABANDI, Knoxville, TN (US)

(21) Appl. No.: 18/205,289

(22) Filed: Jun. 2, 2023

(51) Int. Cl. B60L 53/12; B60L 50/51; H02J 50/12; H02J 50/40

(52) U.S. Cl. CPC B60L 53/12; B60L 50/51; H02J 50/12; H02J 50/402

(57) ABSTRACT

A wireless power transfer (WPT) device includes an in-wheel electric motor having a rotor and a stator having at least one phase coil, a resonant network, and at least one switch configured to selectively connect the resonant network to the phase coil and disconnect the resonant network from the at least one phase coil. A processing device is configured to determine that the at least one phase coil is adjacent to at least one transmitter coil of a WPT transmitter that transmits high-frequency AC power, and operate the at least one switch to close a connection between the resonant network and the phase coil. The phase coil is configured as a receiver coil to receive the high-frequency AC power from the at least one transmitter coil when the at least one switch is closed.

### STATEMENT REGARDING FEDERALLY SPONSORED RESEARCH AND DEVELOPMENT

The technologies described herein were developed with government support under Contract No. DE-AC05-00OR22725 awarded by the U.S. Department of Energy. The government has certain rights in the described technologies.

### BACKGROUND

Electric vehicles (EVs) and plug-in hybrid vehicles are increasingly commonplace. One primary component of an EV is the battery which must be charged. Some EVs and plug-in hybrid vehicles may be charged using wireless inductive power transfer based charging systems. Wireless inductive power transfer based charging systems use electromagnetic induction to transmit power from a transmitter coil to a receiver coil located inside the vehicle. High frequency power is transferred from the transmitter coil to the receiver coil through a large airgap and is fed from the receiver coil to a rectifier which charges the battery. Both the transmitter and receiver coils may have compensation networks which reduce the reactive power requirement and improve efficiency. The distance between the transmitter and receiver coils ranges from several to hundreds of millimeters, and the power level is often in the order of kilo-Watts. Wireless charging eliminates the need for cables and connectors, and may enable more frequent charging, thereby reducing the need for fast charging.

Some conventional technologies for wireless charging of electric vehicle batteries use receiver coils external to the electric motor. Other conventional technologies for wireless charging of electric vehicle batteries combine the motor inverter and charger power electronics. A wireless in-wheel motor was proposed in previous work, in which power is transferred from a transmitter on the vehicle chassis to a receiver coil integrated with the in-wheel motor. The power from the receiver coil is processed through a compensation network and a rectifier which feeds a three-phase motor side inverter. This system avoids the need for power cables from the chassis to the in-wheel motor. A similar system was proposed for an in-wheel switched reluctance motor in the prior art, in which integration of the receiver coil with an in-wheel motor was proposed for an 18 kW, 85 kHz dynamic wireless charging system. The direct-drive in-wheel motor is integrated with the receiver coil, rectifier and inverter. The power transferred from the transmitter located on the ground is directly used for driving as well as charges a battery via a dc-dc converter. However, in each of these conventional technology examples, the receiver is a separate coil integrated with the motor casing.

Conventional technologies for wireless charging of electric vehicle batteries use receiver coils external to the electric motor. Such conventional approaches result in the need for additional hardware devices to enable wireless charging of the EV, which results in additional costs, weight, and volume.

### SUMMARY

To address these and other concerns, an improved in-wheel wireless (e.g., inductive) power transfer device and system, as well as an EV that utilizes the improved wireless power transfer device and system, are disclosed. Additionally, a method for wireless power transfer is also disclosed.

An inductive wireless charging system has some features in common with an electric motor, namely coils and magnetic cores. The present disclosure utilizes one or more of the electric motor coils as a receiver coil in the wireless charging system. Power is wirelessly transferred from external transmitter coils to the batteries through the motor windings and power electronics. More specifically, in-wheel motor and receiver coils are used in combination.

In accordance with various embodiments, wireless power transfer (WPT) device includes an in-wheel electric motor including a rotor and a stator disposed concentrically with the rotor, wherein the stator comprises at least one phase coil. The WPT device includes a resonant network, and at least one switch configured to selectively connect the resonant network to the at least one phase coil and disconnect the resonant network from the at least one phase coil. The device also includes a processing device configured to determine that the at least one phase coil is adjacent to at least one transmitter coil of a WPT transmitter that transmits high-frequency AC power, and operate the at least one switch to close a connection between the resonant network and the at least one phase coil. The at least one phase coil is configured as a receiver coil to receive the high-frequency AC power from the at least one transmitter coil when the at least one switch is closed.

In accordance with various embodiments, a method for wireless power transfer (WPT) for an electric vehicle includes determining that at least one phase coil of the stator is adjacent to at least one transmitter coil of an WPT transmitter that transmits high-frequency AC power, and operating at least one switch to close a connection between a resonant network and the at least one phase coil. The method may include receiving, by the at least one phase coil configured as a receiver coil, the high-frequency AC power from the at least one transmitter coil when the switch is closed.

In accordance with the various embodiments disclosed herein, the disclosed technologies eliminate the need for a separate receiver coil for WPT. As such, the disclosed technologies can reduce the number components, which can lead to a reduction in cost, assembly effort, weight, and complexity. Compactness is another possible benefit of the disclosed technologies. In various embodiments, the rectifier functionality can be realized by the traction inverter connected to the e-motor. In various approaches, having the charging feature fully realized through the e-motor path enables the possibility to also remove an on-board-charger from the vehicle, further increasing the cost saving, optimized compactness, and weight reduction.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 illustrates a side view schematic diagram of a motor in accordance with various embodiments;

FIG. 2 illustrates a side view schematic diagram of a motor utilizing a Halbach array in accordance with various embodiments;

FIG. 3 illustrates a side view schematic diagram of a motor showing flux paths in accordance with various embodiments;

FIG. 4 illustrates a schematic diagram of a wireless power transfer (WPT) system in accordance with various embodiments;

FIG. 5 illustrates a partial perspective view of a motor in accordance with various embodiments;

FIG. 6 illustrates an electric motor in accordance with various embodiments; and

FIG. 7 illustrates an example of the flux density in the magnetic core of the stator in accordance with various embodiments.

### DETAILED DESCRIPTION OF THE DRAWINGS

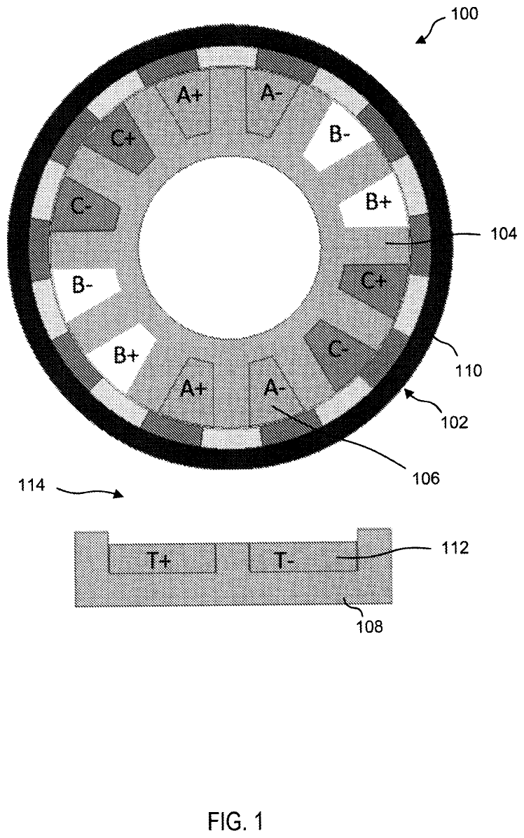

FIG. 1 illustrates a side view schematic diagram for an integrated combined EV motor 100 that also functions as a wireless charging receiver in accordance with various embodiments. In various embodiments, the motor 100 is an in-wheel electric motor of an electric vehicle (EV) including a rotor 102 and a stator 104 disposed concentrically with the rotor 102, wherein the stator 104 comprises at least one phase coil 106. In various approaches, the motor 100 may be an outer rotor motor (e.g., an external rotor motor) with fractional slot concentrated windings and surface permanent magnet rotor. An outer rotor configuration may be utilized for two reasons. First, it enables better coupling between a transmitter 108 and the motor coils 106. Second, external rotor motors are commonly used as direct-drive in-wheel motors, as they are compact, improve efficiency due to the elimination of gearing, and reduce complexity. In various embodiments, the motor 100 is a traditional radial flux electric motor, where flux is radial to the axle of the motor 100. In other embodiments discussed herein, the motor 100 is an axial flux motor, where flux is axial to the motor 100.

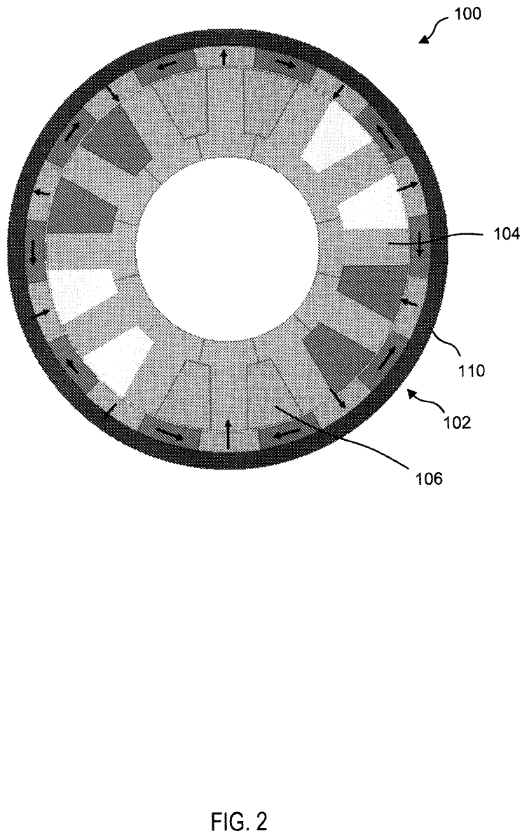

In various embodiments, the motor 100 utilizes a Halbach array magnetization pattern, which enables the use of a non-magnetic back iron or support 110. An example of a rotor 102 utilizing the Halbach array magnetization pattern is shown in FIG. 2, which shows the magnetization directions of permanent magnets in a 2-segment per pole Halbach array. Such an array can eliminate the need for a magnetic back iron, thereby allowing for a non-conducting, non-magnetic support 110. The radial and circumferential magnets of the Halbach array reduce the flux at the back of the array and direct the flux in the motor airgap. The Halbach array enables the use the non-conducting, non-magnetic support 110. For example, if the magnets were radially magnetized instead, the rotor back would need to be magnetic in order to provide a path for the flux. This would result in shielding of the high frequency magnetic field from the transmitter 108, thereby reducing the efficiency of the coupling. The coupling can be improved by replacing the radially magnetized permanent magnets by the Halbach array. In this approach, a magnetic rotor back iron is not required for motor operation, and the coupling between the transmitter 108 and motor coils 106 is improved. This type of design can use a rotor support 110 made from a composite material, carbon fiber reinforced polymer, or other non-conducting non-magnetic materials. In various embodiments, an external Halbach array rotor along with a stator having a single layer fractional slot concentrated windings is found to be a suitable motor topology which would enable the use of one or more motor coils as a receiver coil.

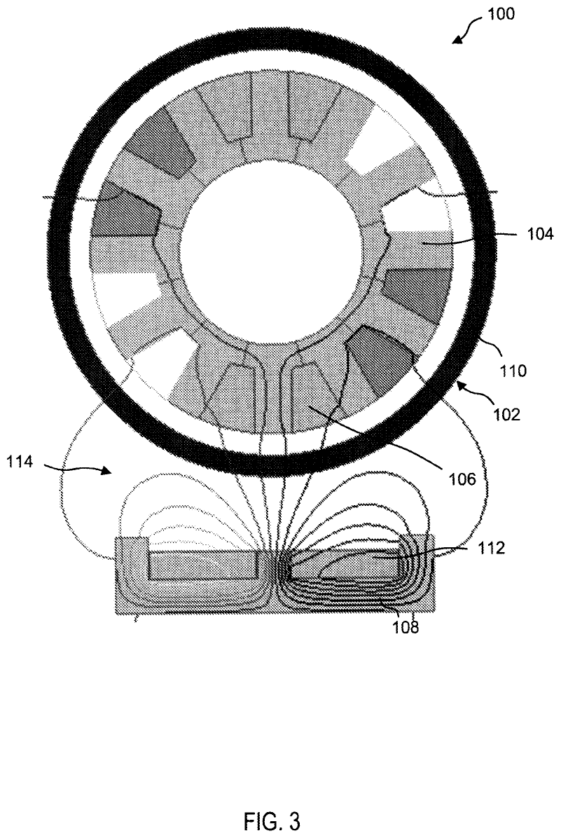

Example flux paths between the transmitter 108 and coils 106 of the motor 100 are illustrated in FIG. 3. As shown, the flux from the transmitter 108 couples primarily with the motor coil or coils 106 located physically close to it.

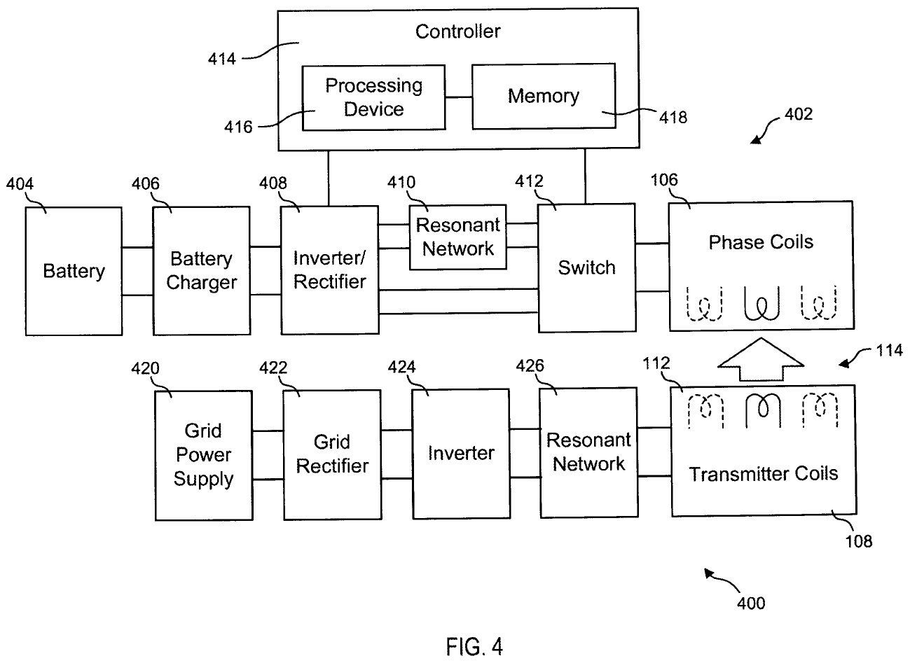

FIG. 4 illustrates an example schematic diagram of a wireless power transfer (WPT) system 400, including a WPT device 402 in accordance with various embodiments. As discussed above, the WPT device 402 includes at least one in-wheel electric motor 100 of an electric vehicle comprising a rotor 102 and a stator 104 disposed concentrically with the rotor 102, wherein the stator 104 comprises at least one phase coil 106. As discussed above, the rotor may be configured as a Halbach array in various embodiments.

In various embodiments, the motor 100 is a radial flux electric motor. In such an approach, the stator 104 may be disposed inside the rotor 102. As illustrated in FIG. 1, in such an application, the at least one phase coil 106 may be configured to receive the high-frequency AC power in a vertical direction when the motor 100 is oriented so that its axis of rotation is principally horizontal. For example, the transmitter 108 may be placed on the ground or other surface below the motor 100 and the wheel in which the motor 100 is mounted. However, other arrangements are contemplated with radial flux motors, as long as a principle direction of the high-frequency AC power is substantially perpendicular to the axis of rotation of the motor 100.

A gap 114 may exist between the at least one phase coil 106 of the motor 100 and the at least one transmitter coil 112 of the WPT transmitter 108. The high-frequency AC power is transmitted from the transmitter coil 112 to the at least one phase coil 106 of the motor 100 functioning as a receiver coil through this gap 114. In various embodiments, the gap 114 is in a range of 5 cm to 30 cm. As discussed above, in order to maximize coupling, a non-conducting, non-magnetic support 110 may be disposed concentrically with and at least in part within the gap 114 between the at least one phase coil 106 and the at least one transmitter coil 112 of the WPT transmitter 108. The support 110 is connected to and configured to support at least the rotor 102. In various embodiments, the rotor 106 of the in-wheel electric motor 100 has a diameter in a range of 20 cm to 40 cm.

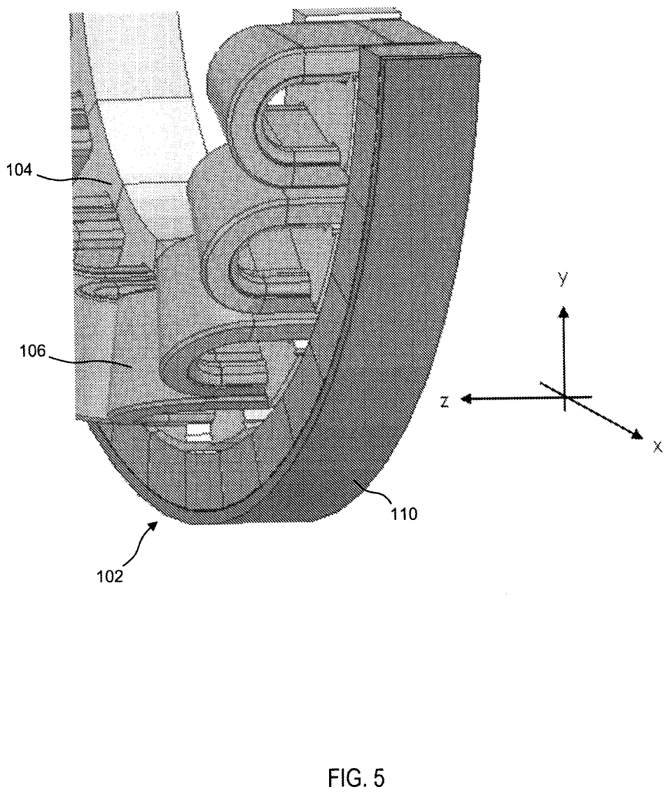

In various embodiments, the at least one phase coil 106 is arranged in at least one of a single layer or a double layer. In various embodiments, as is illustrated in FIG. 5, which shows a partial perspective view of the motor 100 in accordance with various embodiments, the end windings of the coils of the stator 104 may extend significantly beyond the stack and the support 110 to increase the overlapping area with the transmitter coil 112.

As is shown in FIG. 4, the at least one phase coil 106 of the stator 104 of the motor 100 may include a single phase coil or a plurality of phase coils (e.g., for use with polyphase wireless charging). These may correspond to and be configured to each receive high-frequency AC power from a single transmitter coil 112 or a plurality of transmitter coils 112 of the transmitter 108.

In certain embodiments, the WPT device 402 also may include a resonant network 410 (also called a compensation network or a compensation circuit). Various known circuit configurations for resonant networks 410 are contemplated, and generally include one or more capacitors and/or inductors electrically connected in series and/or parallel with the phase coil 106 functioning as the receiver. The resonant network 410 serves to reduce the reactive power requirement and to improve efficiency of the wireless charging. In embodiments where more than one phase coil 106 of the stator 104 are utilized as receiver coils, each receiver coil may have its own associated resonant network 410, or may share resonant networks 410 with other phase coils operating as receiver coils. In certain embodiments, the transmission side may also include one or more resonant networks 426 electrically connected to the one or more transmitter coils 112, which likewise serve to improve charging efficiency.

In various embodiments, the WPT device 402 also includes at least one switch 412 configured to selectively connect the resonant network 410 to the at least one phase coil 106 and/or disconnect the resonant network 410 from the at least one phase coil 106. The switch 412 may include a single switch or multiple switches to selectively connect or bypass the resonant network 410 from the at least one phase coil 106. Specifically, when wireless charging is activated, the switch 412 may connect the resonant network 410 to the at least one phase coil 106. As such, the at least one phase coil 106 is configured as a receiver coil to receive the high-frequency AC power from the at least one transmitter coil 112 when the at least one switch 412 is closed. However, when the motor 100 is no longer charging and/or in an active traction mode, the switch 412 may bypass the connection to the resonant network 410 in order to disconnect the resonant network 410 from the at least one phase coil 106. As mentioned above, multiple phase coils 106 may be utilized in various embodiments (e.g., with polyphase wireless charging). As such, a plurality of switches 412 may be provided to selectively connect individual phase coils 106 to one or more different resonant networks 410. Similarly, different phase coils 106 may be activated for wireless charging at different times, and the switch 412 may operate to connect different phase coils 106 to a shared resonant network 410 at different times or at the same time. The switch 412 may include one or more relays, transistors, or other switching devices capable of selectively connecting and disconnecting the resonant network 410 from the at least one phase coil 106. In one embodiment, the switch 412 may be implemented as part of the switches of the traction inverter 408 of the in-wheel electric motor, which may be able to open or close to selectively connect or disconnect the resonant network 410 from the at least one phase coil 106.

In certain embodiments, the stator 104 comprises a plurality of pairs of phase coils 106, the phase coils 106 of each pair being electrically connected in series or parallel. The switch 412 (or another switch, or the traction inverter 408) may be configured to open an electrical connection (i.e., the series or parallel connection) between the at least one phase coil 106 and its paired phase coil prior to the at least one phase coil 106 receiving the high-frequency AC power transmitted by the at least one transmitter coil 112. Similarly, the switch 412 (or another switch, or the traction inverter 408) may be able to selectively close or open a connection to at least one other phase coil of the plurality of pairs of phase coils to selectively connect or disconnect the at least one other phase coil, e.g., from the remainder of the components of the WPT device. In this manner, the other phase coil can be disconnected from the circuit so as to help ensure that only the selected phase coil 106 is strongly coupled to the transmitter 108, helping achieve high q-factor, reducing leakage inductance, and further increasing the efficiency of the at least one phase coil 106 that is operating as a receiver coil.

The WPT device 402 may include a controller 414, which may further include at least one processing device 416 coupled to a memory device 418. The controller 414 may be a single controller 414 or may be implemented across a plurality of different controller modules. The controller 414 may be, in part, implemented as part of a traction inverter controller, a battery charger controller, an ECU, or may be a dedicated wireless power transfer controller. The processing device 416 may be a Central Processing Unit (CPU), microcontroller, or a microprocessor, and/or may include or be implemented with an Application Specific Integrated Circuit (ASIC), Programmable Logic Device (PLD), or Field Programmable Gate Array (FPGA). The processing device 416 and/or the controller 414 as a whole may also be implemented with circuitry that includes discrete logic or other circuit components, including analog circuit components, digital circuit components or both. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. The memory 130 may comprise a flash memory, a Random Access Memory (RAM), a Read Only Memory (ROM), an Erasable Programmable Read Only Memory (EPROM), a Hard Disk Drive (HDD), other magnetic or optical disk, or another machine-readable nonvolatile medium or other tangible storage mediums other than a transitory signal. The memory 418 may store therein software modules, code, and/or instructions that, when executed by the processing device 416, cause the processing device 416 to implement some or all of the processes described herein or illustrated in the drawings. The memory 418 may also store other data for use by the processing device 416 and/or historical information regarding the operation of the controller 414, other components, and or the vehicle as a whole.

In various embodiments, the at least one processing device 416 may be configured to determine that the at least one phase coil 106 is adjacent to at least one transmitter coil 112 of the WPT transmitter 108 that transmits high-frequency AC power. For example, the processing device 416 may utilize sensors to sense the high-frequency AC power from the transmitter coil 112. The processing device 416 may periodically or cyclically detect, through the at least one phase coil 106, whether the high-frequency AC power from the transmitter coil 112 is present on or received by (e.g., above a threshold amount) the at least one phase coil 106. In some embodiments, the WPT system 100 includes a coil detection system including an additional sensing coil and communications devices in each of the transmitter 108 and the receiver side. In such embodiments, the wireless power transfer happens only when the transmitter 108 detects the presence of a compatible receiver (e.g., receiver coil 106) via the additional sensing coil. Upon detection, both the transmitter 108 and the receiver (e.g., the WPT device 402 on the EV) exchanges information about their configurations, such as topology, voltage levels, required voltage, and current to charge the battery, etc. Once the communications are complete and compliant, the transmitter 108 will start switching its high-frequency inverter (e.g., inverter 424) and sending the high-frequency AC power.

The at least one processing device 416 may be operationally coupled to the at least one switch 412 and may be configured to operate the at least one switch 412 to close a connection between the resonant network 410 and the at least one phase coil 106. As mentioned above, this allows for selective connecting or disconnecting (e.g., bypassing) of the resonant network 410 to or from the at least one phase coil 106 dependent on whether the vehicle is in a charging or driving mode. The at least one processing device 416 may receive input information from other control systems within the vehicle in order to determine that the in-wheel electric motor is stationary or has been disengaged from the vehicle's driving train, e.g., to determine whether to place the vehicle in a charging mode and to operate the switch 412 to connect the resonant network 410 to the at least one coil 106.

In embodiments where the stator 104 comprises a plurality of pairs of phase coils 106, the processing device 416 may also be configured to control the switch 412, another switch, or the traction inverter 408 to open an electrical connection (i.e., series or parallel connection) between the at least one phase coil 106 and its paired phase coil prior to the at least one phase coil 106 receiving the high-frequency AC power transmitted by the at least one transmitter coil 112.

In embodiments that include a plurality of phase coils 106 which may be selectively activated as the receiver coil or as multiple different receiver coils, the processing device 416 may be configured to select the at least one phase coil 106 from the plurality of pairs of phase coils that is adjacent to the at least one transmitter coil 112 of the WPT transmitter 108. That is, the processing device 416 may determine which phase coil or coils 106 are closest to the transmitter coil(s) 112 based on a received strength of the AC signal via each different phase coil. In various approaches, during the receiver coil detection process discussed above, the at least one transmitter coil 112 may send a low power AC signal. The receiver coil 106 that is closest to the transmitter coil 112 will have a higher induced voltage compared to the other coils. Based on this received induced voltage, the processing device 416 can determine which at least one coil 106 is/are closest to the at least one transmitter coil 112. Alternatively, for example, in a radial flux electric motor configuration, the processing device 416 may select a phase coil 106 that is on the bottom or closest to the ground as the phase coil 106 to operate as the receiver coil, relying on the assumption that charger transmitter 108 is on the ground or surface below the wheel (and thus would be the closest to that bottom phase coil 106). Other methods are contemplated for determining which phase coil or phase coils 106 are adjacent to a transmitter coil 112.

Processing device 416 may also be configured to control the switch 412 (or another switch, or the traction inverter 408) to selectively close or open a connection to at least one other phase coil (e.g., a non-selected phase coil) of the plurality of pairs of phase coils to selectively connect or disconnect the at least one other phase coil, e.g., from the remainder of the components of the WPT device.

In various embodiments, the WPT device 402 includes a rectifier 408 electrically coupled through the resonant network 410 to the at least one phase coil 406. The rectifier 408 may be configured to rectify the high-frequency AC power received by the at least one phase coil 106, and output the rectified high-frequency AC power as DC power to an on-board battery charger 406. The on-board battery charger 406 is configured to receive the DC power from the rectifier 408 and to charge at least one battery 404 using the DC power. In various embodiments, the rectifier 408 comprises the traction inverter 408 of the in-wheel electric motor. The inverter/rectifier 408 is used as an inverter for driving, but is used as a rectifier to charge the battery 404. This provides an advantage in that no additional components are required to rectify the AC power as the inverter is already present within the system.

In various embodiments, the transmitter side of the WPT system 400 may include a grid power supply 420, for example, to provide power from a power grid. A grid rectifier 422 may convert the grid AC power to DC power. An inverter 424 may then convert the DC power into high-frequency AC power for transmission to the receiver coils 106. The transmitter side also includes the transmitter coils 112 of the transmitter 108, which may also be connected to a resonant network 426.

In various embodiments, the transmitter coil 112 provides a single phase high-frequency AC power. However, in other embodiments, multiple transmitter coils 112 (e.g., at least three) are provided to provide a polyphase high-frequency AC power. In various embodiments, the transmitter coil 112 is a circular coil, a rectangular coil, or a DD coil, and may include a ferrite core. The transmitter coil 112 may have an AC power transmission axis predominantly parallel to the vertical direction in some embodiments (e.g., when used with radial flux electric motors). However, in other embodiments, the transmitter coil 112 may have an AC power transmission axis predominantly parallel to the horizontal direction (e.g., when used with axial flux electric motors). In particular approaches, the high-frequency AC power is in a range of 5-50 kW, and may have a fundamental frequency at 10 s of kHz, and may be in a range of 3 kHz-10 MHz, with 20 kHz as a particular example.

While the embodiments above are described principally for use with radial flux electric motors, these teachings apply in a similar manner to use with axial flux electric motors in other embodiments. Axial flux electric motors are being used with increasing frequency in EVs, and much of the above disclosure applies equally to such axial flux electric motors. A first difference is that, with radial flux motors, the axis of high-frequency AC power transmission is vertical, or at least perpendicular to the axis of the motor 100, while with axial flux motors, the axis of high-frequency AC power transmission is horizontal, or at least parallel to the axis of the motor 100. Thus, while the transmitter 108 may be placed below the wheel with radial flux motors, the transmitter 108 may be placed on a side of the wheel with axial flux motors. Further, due to the configuration of such axial flux motors, and the placement of the transmitter 108, axial flux motors can more easily and effectively implement polyphase charging with a higher power density than single phase charging. The following embodiments disclose the variations for using such axial flux motors as charging receivers for wireless charging.

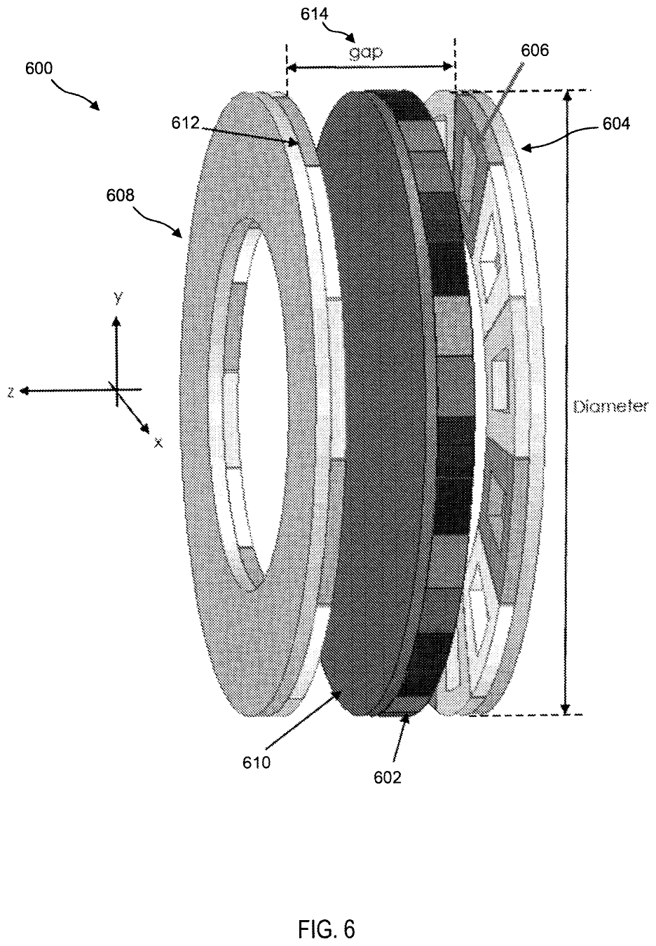

FIG. 6 illustrates an axial flux electric motor 600 in accordance with various embodiments. As with the motor 100 (e.g., the radial flux motor 100), the motor 600 includes a rotor 602 including a support 610, and a stator 604 including at least one phase coil 606. The motor may be a slot-less axial flux type with a Halbach array magnet-rotor 602 including magnets and a non-magnetic/non-conducting rotor support 610.

In various embodiments, the stator 604 comprises a plurality of phase coils 606. The plurality of phase coils 606 may be in a polyphase arrangement. The stator 604 is disposed adjacent to the rotor 602 in a horizontal direction. A non-conducting, non-magnetic support 610 is disposed at least in part within a gap 614 between the plurality of phase coils 606 and the at least one transmitter coil 612 of the WPT transmitter 608, the support 610 disposed parallel to a plane of the rotor 602 and connected to the rotor 602 to support at least the rotor 602.

In various embodiments, the high-frequency AC power from the transmitter 608 is polyphase high-frequency AC power. Accordingly, the plurality of phase coils 606 are configured to receive the polyphase high-frequency AC power in the horizontal direction from the WPT transmitter 608. The plurality of phase coils 606 may be arranged in a one-to-one correspondence with, and spaced apart through a gap 614 from, a plurality of transmitter coils 612 of the WPT transmitter 606 configured to transmit the polyphase high-frequency AC power in the horizontal direction. The transmitter coils 612 will be mutually coupled with the stator coils 606 and power is transferred wirelessly and processed by the WPT device of the EV. In such an arrangement, power density and transfer efficiency is improved.

The system illustrated in FIG. 4 applies equally to the embodiment using the axial flux motor of FIG. 6. As such, in similar or identical manner as was discussed above, the at least one switch 412 is configured to selectively connect the resonant network 410 to the plurality of phase coils 606 and disconnect the resonant network 410 from the plurality of phase coils 606. Likewise, the at least one processing device 416 is configured to operate the at least one switch 412 to close a connection between the resonant network 410 and at least some of the plurality of phase coils 606. In this arrangement, at least some of the plurality of phase coils 606 are configured as receiver coils to receive the polyphase high-frequency AC power from the at least one transmitter coil 612 when the at least one switch 412 is closed.

In accordance with various embodiments, a method is disclosed for wireless power transfer (WPT) for an EV including at least one in-wheel electric motor (e.g., motor 100 or 600) comprising a rotor and a stator disposed concentrically with the rotor. The method includes determining, by at least one processing device 416 of a WPT device, that at least one phase coil of the stator is adjacent to at least one transmitter coil of an WPT transmitter that transmits high-frequency AC power. The method also includes operating, by the at least one processing device 416, at least one switch to close a connection between a resonant network and the at least one phase coil, and receiving, by the at least one phase coil configured as a receiver coil, the high-frequency AC power from the at least one transmitter coil when the switch is closed.

In certain embodiments, the stator comprises a plurality of pairs of phase coils including the at least one phase coil, the phase coils of each pair being connected in series. The method may then include opening a serial connection between the at least one phase coil and its paired phase coil prior to receiving, by the at least one phase coil, the high-frequency AC power transmitted by the at least one transmitter coil. The method may also include selecting, by the at least one processing device 416, the at least one phase coil from the plurality of pairs of phase coils, that is adjacent to the at least one transmitter coil of the WPT transmitter.

In certain embodiments, the stator is disposed inside the rotor (as is shown in FIG. 1). The method may include receiving, by the at least one phase coil, the high-frequency AC power from the at least one transmitter coil in a vertical direction.

In certain embodiments, the stator comprises a plurality of phase coils including the at least one phase coil, the plurality of phase coils in a polyphase arrangement, and the stator may be disposed adjacent to the rotor in a horizontal direction (as is shown in FIG. 6). The method may include operating, by the at least one processing device 416, the at least one switch to close a connection between the resonant network and at least some of the plurality of phase coils. The method may also include receiving, by at least some of the plurality phase coils, a polyphase high-frequency AC power in the horizontal direction from the WPT transmitter.

In a particular embodiment, the motor has an outer diameter of 240 mm and a stack length of 45 mm. Different winding configurations can be used, including single and double layer. A single layer type winding had the highest coupling factor. This may be attributed to the larger overlapping area of the coil 106 with the transmitter coil 112 in the single layer design. A coupling factor may be calculated from the self and mutual inductances determined from 2D magneto-static finite element analysis as follows:

$$k = \frac{M}{\sqrt{{L}_{1} {L}_{2}}}$$

where, M is the mutual inductance between transmitter and receiver, and L₁ and L₂ are the transmitter and receiver self inductances, respectively. The open circuit voltage induced by the mutual coupling between the transmitter and receiver across the receiver terminals is given as:

$${V}_{2} = ω {MI}_{1}$$

where, M is the mutual inductance between the transmitter 108 and receiver coil 106, ω is the angular frequency, and I₁ is the transmitter current.

The power transferred can be calculated from the following:

$$P = M ω {I}_{1} {I}_{2} sin ( {ϕ}_{12} )$$

where I₂ is the receiver current, and ϕ₁₂ is the phase angle between the transmitter and receiver currents. In the case of resonant wireless power transfer, a compensation networks would make the angle ϕ₁₂ approximately 90°. The maximum receiver current I₂ would be equal to the maximum current permissible in the motor windings.

A time-stepped 2D finite element analysis was conducted with the rotor 102 stationary in order to evaluate the performance of the device as a wireless charger. With an example frequency of 20 kHz and with the motor winding current set at its rated value, it is found that 15 kW of power can be transferred, as shown in Table 1, below. It may be noted that the inverter power limitation is not considered in this calculation, and the actual power transfer capability could be impacted by the power that can be handled by the motor drive. The value 20 kHz is chosen in this example as it is close to PWM switching frequencies normally used in motor drives. Other performance parameters are summarized in Table 1. Little or no demagnetization of the permanent magnets is observed.

TABLE 1

| | |
|---|---|
| Receiver self-inductance [uH] | 96.67 |
| Transmitter-receiver mutual inductance [uH] | 13.34 |
| Transmitter self-inductance [uH] | 63.66 |
| Frequency [kHz] | 20 |
| Coupling factor | 0.17 |
| Power transfer capability [kW] | 15 |
| Airgap between transmitter and receiver [mm] | 70 |
| Efficiency | ≥85% |

The most commonly used motors presently in EV applications are interior permanent magnet motors. In such motors, the rotor has one or more layers of permanent magnets buried inside. Such machines normally tend to be configured with the stator outside and rotor inside. The external stator is made from magnetic steel for normal motor operation. As such, the high frequency magnetic field from the transmitter 108 would be almost completely shielded by the stator core in such an arrangement. Accordingly, external rotor motors, which can be designed without a magnetic back iron or support are better suited to enable improved coupling. Direct drive in-wheel motors with an external rotor directly coupled to the motor wheels are described herein. Thus, the disclosed technologies are expected to be best suited for in-wheel EV motors. In order to maximize coupling and efficiency, metal and conducting materials should not be present between the transmitter 108 and receiver coils 106.

Another design consideration is the thickness of the rotor support material and the wheel rim (not shown). A larger thickness of the rotor support 110 and the wheel rim would increase the airgap between the transmitter coil 112 of the transmitter 108 and the phase coil 106 of the motor 100 functioning as the receiver. The coupling factor reduces with the increase in airgap. The frequency can be increased to enable power transfer across larger airgaps, however, motor laminations are normally not rated to operate at very high frequencies. Accordingly, there is an incentive to reduce the gap between the transmitter coil 112 of the transmitter 108 and the phase coil 106 of the motor 100 functioning as the receiver.

A maximum theoretical efficiency of power transfer between the transmitter 108 and receiver coils 106 may be calculated as follows:

$${η}_{max} = \frac{{k}^{2} {Q}_{1} {Q}_{2}}{{( 1 + \sqrt{1 + {k}^{2} {Q}_{1} {Q}_{2}} )}^{2}}$$

where k is the coupling factor and Q₁ and Q₂ are the transmitter and receiver coil quality factors, respectively. The maximum efficiency increases with increase in the coil quality factors as well as the coupling factor. The coil quality factors would also be impacted by the loss in the core at 20 kHz.

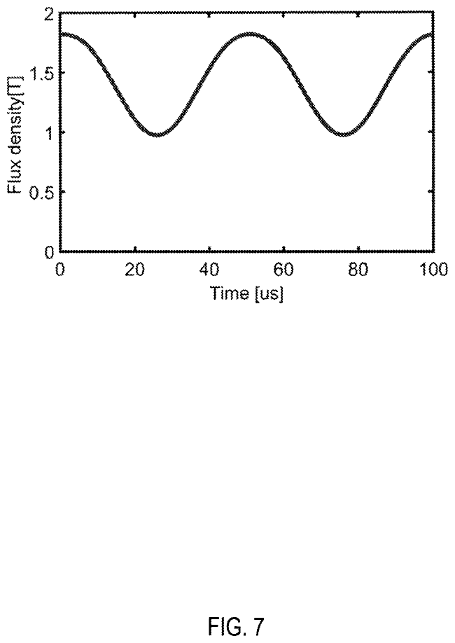

An example of the flux density in the magnetic core of the stator 104 around which the receiver coil 106 is wound is shown in FIG. 7. As shown, the flux density has a DC component, introduced by the stationary permanent magnets, and an AC component at 20 kHz (e.g., the transmitter frequency). The AC amplitude depends on the currents, airgap, and coupling. The flux density in other parts of the stator 104 further away from the transmitter coil 108 would have lower AC amplitudes. The core loss caused by this high-frequency flux density is evaluated and found to be less than, for example, 10% of the rated power, when a high-frequency motor lamination is employed, in accordance with various embodiments.

Compensation networks on both the transmitter and receiver sides resonating with the coil self-inductance can be used to ensure maximum power transfer at a given current to minimize the coil and power electronics VA rating. Here, as discussed above, provisions (e.g., switches or other devices) to bypass the compensation network on the receiver side during motor operation can be made.

In various embodiments, the traction inverter is used as an active front end rectifier during the charging operation. A similar technique can be used herein to process the power from the receiver motor windings. However, in single-phase charging arrangements, this may require the traction inverter to operate in single phase mode during charging, leading to higher current stress on one leg of the inverter. For the geometry as shown in FIG. 3, only one of the motor windings 106 is coupled with the transmitter coils 112, which increases the self-inductance, thus lowering the coupling factor. Therefore, a switch or other device for breaking a series or parallel connection between two coils of the same phase during the charging operation may be included in order to maximize the coupling factor and efficiency.

The quality factor is the ratio of energy stored to the energy dissipated per cycle. Energy can be dissipated due to AC and DC loss in the motor windings, lamination core loss, and induced currents in the permanent magnets. The motor windings are generally made from, for example, solid or stranded copper, and the core laminations from 3.5% Si-steel. These materials are generally rated to operate at higher flux density, and lower fundamental frequencies. These factors are to be taken into account during the design phase.

Additionally, due to the availability of wide band gap devices, the switching and fundamental frequency of EV motors are increasing, necessitating the use of Litz wire for the conductors, thin high-frequency steels, as well as highly segmented permanent magnets. Thus, designing for tens of kHz in charging frequency is not expected to be a fundamental design challenge. The voltage developed across the coils at resonance is a function of the coil Q-factor, and can be larger than the normal motor operating voltage. However, the motor winding insulation should be rated for this voltage.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A wireless power transfer (WPT) device comprising:
at least one in-wheel electric motor of an electric vehicle comprising a rotor and a stator disposed concentrically with the rotor, wherein the stator comprises at least one phase coil;
a resonant network;
at least one switch configured to selectively connect the resonant network to the at least one phase coil and disconnect the resonant network from the at least one phase coil; and
at least one processing device configured to:
determine that the at least one phase coil is adjacent to at least one transmitter coil of a WPT transmitter that transmits high-frequency AC power; and
operate the at least one switch to close a connection between the resonant network and the at least one phase coil,
wherein the at least one phase coil is configured as a receiver coil to receive the high-frequency AC power from the at least one transmitter coil when the at least one switch is closed.

2. The WPT device according to claim 1, comprising:
a non-conducting, non-magnetic support disposed concentrically with and at least in part within a gap between the at least one phase coil and the at least one transmitter coil of the WPT transmitter, wherein the support is connected to and configured to support at least the rotor.

3. The WPT device according to claim 1,
wherein the stator comprises a plurality of pairs of phase coils including the at least one phase coil, the phase coils of each pair being electrically connected in series or parallel.

4. The WPT device according to claim 3,
wherein the at least one processing device is configured to:
open an electrical connection between the at least one phase coil and its paired phase coil prior to receiving, by the at least one phase coil, the high-frequency AC power transmitted by the at least one transmitter coil.

5. The WPT device according to claim 3,
wherein the rotor is configured as a Halbach array.

6. The WPT device according to claim 3,
wherein the at least one processing device is configured to:
select the at least one phase coil from the plurality of pairs of phase coils, that is adjacent to the at least one transmitter coil of the WPT transmitter; and
open a connection to at least one other phase coil of the plurality of pairs of phase coils to disconnect the at least one other phase coil.

7. The WPT device according to claim 1,
wherein the at least one processing device is configured to:
determine that the in-wheel electric motor is stationary or has been disengaged from the vehicle's driving train.

8. The WPT device according to claim 1,
wherein the non-conducting, non-magnetic support comprises a composite material.

9. The WPT device according to claim 1, comprising:
a rectifier electrically coupled through the resonant network to the at least one phase coil, wherein the rectifier is configured to:
rectify the high-frequency AC power received by the at least one phase coil; and
output the rectified high-frequency AC power as DC power to an on-board battery charger.

10. The WPT device according to claim 9,
wherein the rectifier comprises a traction inverter of the in-wheel electric motor.

11. The WPT device according to claim 1,
wherein the stator is disposed inside the rotor, and
wherein the at least one phase coil is configured to receive the high-frequency AC power in a vertical direction.

12. The WPT device according to claim 1,
wherein the at least one phase coil is arranged in at least one of a single layer or a double layer.

13. The WPT device according to claim 1,
wherein the stator comprises a plurality of phase coils including the at least one phase coil, the plurality of phase coils in a polyphase arrangement,
wherein the high-frequency AC power is polyphase high-frequency AC power,
wherein the stator is disposed adjacent to the rotor in a horizontal direction,
wherein the plurality of phase coils are configured to receive the polyphase high-frequency AC power in the horizontal direction from the WPT transmitter,
wherein the at least one switch is configured to selectively connect the resonant network to the plurality of phase coils and disconnect the resonant network from the plurality of phase coils,
wherein the at least one processing device is configured to:
operate the at least one switch to close a connection between the resonant network and at least some of the plurality of phase coils, and
wherein the at least some of the plurality of phase coils are configured as receiver coils to receive the polyphase high-frequency AC power from the at least one transmitter coil when the at least one switch is closed.

14. The WPT device according to claim 13, comprising:
a non-conducting, non-magnetic support disposed at least in part within a gap between the plurality of phase coils and the at least one transmitter coil of the WPT transmitter, the support disposed parallel to a plane of the rotor and connected to the rotor to support at least the rotor.

15. The WPT device according to claim 13,
wherein the plurality of phase coils are arranged in a one-to-one correspondence with, and spaced apart through a gap from, a plurality of transmitter coils of the WPT transmitter configured to transmit the polyphase high-frequency AC power in the horizontal direction.

16. A method for wireless power transfer (WPT) for an electric vehicle including at least one in-wheel electric motor comprising a rotor and a stator disposed concentrically with the rotor, the method comprising:
determining, by at least one processing device of a WPT device, that at least one phase coil of the stator is adjacent to at least one transmitter coil of an WPT transmitter that transmits high-frequency AC power;
operating, by the at least one processing device, at least one switch to close a connection between a resonant network and the at least one phase coil; and
receiving, by the at least one phase coil configured as a receiver coil, the high-frequency AC power from the at least one transmitter coil when the switch is closed.

17. The method according to claim 16,
wherein the stator comprises a plurality of pairs of phase coils including the at least one phase coil, the phase coils of each pair being connected in series;
wherein the method comprises:
opening a serial connection between the at least one phase coil and its paired phase coil prior to receiving, by the at least one phase coil, the high-frequency AC power transmitted by the at least one transmitter coil.

18. The method according to claim 17, comprising:
selecting, by the at least one processing device, the at least one phase coil from the plurality of pairs of phase coils, that is adjacent to the at least one transmitter coil of the WPT transmitter.

19. The method according to claim 16,
wherein the stator is disposed inside the rotor, and
wherein the method comprises:
receiving, by the at least one phase coil, the high-frequency AC power from the at least one transmitter coil in a vertical direction.

20. The method according to claim 16,
wherein the stator comprises a plurality of phase coils including the at least one phase coil, the plurality of phase coils in a polyphase arrangement, and
wherein the stator is disposed adjacent to the rotor in a horizontal direction;
the method comprising:
operating, by the at least one processing device, the at least one switch to close a connection between the resonant network and at least some of the plurality of phase coils; and
receiving, by at least some of the plurality phase coils, a polyphase high-frequency AC power in the horizontal direction from the WPT transmitter.
